(19) United States
(12) Patent Application Publication
(10) Pub. No.: US 2023/0250964 A1
(43) Pub. Date: Aug. 10, 2023

(54) MULTI-FUNCTIONAL STOVE

(71) Applicant: SABRINA L. HARMON, Norfolk, VA (US)

(72) Inventor: SABRINA L. HARMON, Norfolk, VA (US)

(21) Appl. No.: 17/666,937

(22) Filed: Feb. 8, 2022

(51) Int. Cl. F24C 3/00; F24C 3/12; B67D 1/00; B67D 1/08

(52) U.S. Cl. CPC F24C 3/008; F24C 3/126; B67D 1/0014; B67D 1/0889; F24C 15/16

(57) ABSTRACT

A multi-functional stove can include a hollow rectangular body, a door pivotally connected to a sidewall of the rectangular body, a plurality of burners attached to a top wall of the rectangular body, and at least one water dispenser connected to a sidewall of the rectangular body. The multi-functional stove can provide multiple cooking options and the additional benefit of providing a proximal source of potable water. The multi-functional stove can provide dual water dispensers including hot and cold water sources, thereby eliminating the need for making trips to a kitchen sink to acquire water during cooking.

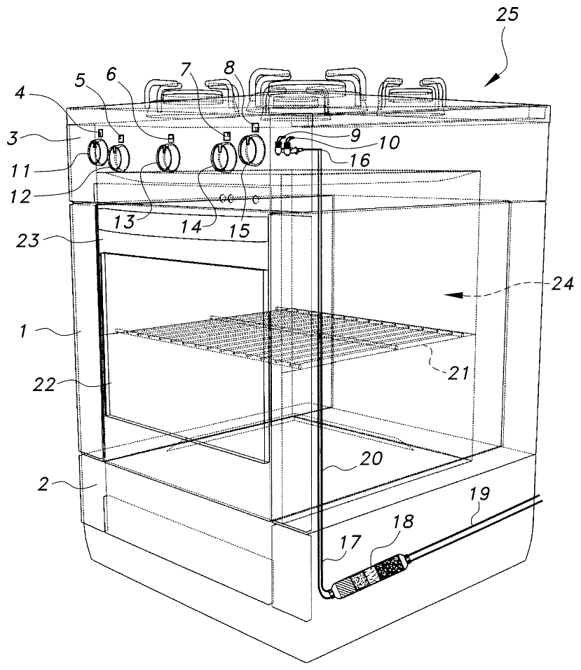

### I. FIELD

The disclosure of the present patent application relates to integrated kitchen appliances and, more particularly, to a multi-functional stove.

### II. DESCRIPTION OF THE PRIOR ART

There is an increasing demand for optimal space allocation in interior design. Appropriate space allocation can be particularly challenging in kitchens, as the need for kitchen appliances must be balanced with the need for ample countertop space for cooking preparation. Accordingly, electrical appliances that provide multi-functionalities are paramount, especially in smaller residences such as studio apartments and lofts. Thus, a multi-functional stove solving the aforementioned problems is desired.

### III. SUMMARY

A multi-functional stove can include a hollow rectangular body, a door pivotally connected to a sidewall of the rectangular body, a plurality of burners attached to a top wall of the rectangular body, and at least one water dispenser connected to a sidewall of the rectangular body. The multi-functional stove can provide multiple cooking options and the additional benefit of providing a proximal source of potable water. The multi-functional stove can provide dual water faucets for dispensing hot and cold water, thereby eliminating the need for making trips to a kitchen sink to acquire water during cooking.

These and other features of the present subject matter will become readily apparent upon further review of the following specification.

### III. BRIEF DESCRIPTION OF THE DRAWINGS

The sole drawing FIGURE illustrates a perspective of the multi-functional stove.

Similar reference characters denote corresponding features consistently throughout the attached drawings.

### IV. DETAILED DESCRIPTION

As shown in the sole drawing FIGURE, a multi-functional stove has a rectangular, block-shaped body (1) with a hollow interior or inner chamber for a cooking oven (24) and a water dispenser (16) connected to the body (1). The cooking oven (24) has heating elements which allow the oven (24) to provide conventional oven functions, such as pre-heating, roasting, convection baking, baking, broiling, slow cooking, bread proofing, warming, dehydrating, and self-cleaning cycle in a conventional manner. A circular knob (13) located in the center of an array of circular knobs controls the oven functions. A control panel (not shown) can enable the user to further select a specific cooking temperature. The control panel can include a cooking time function, a delay start function, a timer, a programmable digital clock for displaying the time of the day, and a light switch for illuminating the interior space of the oven chamber whenever needed. The rear wall of the oven chamber has a light bulb (not shown) residing in a heat protective clear enclosure (not shown) which provides light to the interior space of the oven when the control panel button is pressed to the ‘on’ position. Due to the heat protective enclosure, the oven light can be used when the oven is in use. Also, the enclosure can be unscrewed from the rear wall of the oven such that the bulb can be exchanged when and if the bulb becomes defective. The bulb can be a standard filament light source or in the alternative be an LED light.

The oven (24) can include a metal rack (21) that is a substantially rectangular shape, sized to fit within the oven chamber. The metal rack slides into place by resting on side wall ridges (not shown) such that it snuggly resides in the oven space while bisecting the oven space along the oven's vertical dimension. While only one rack (21) is shown, it is readily apparent that the oven can accommodate several racks in a stacked fashion so that dishes can be inserted at multiple heights in the oven space.

The front of the multi-functional stove has a door (23) which opens outward and forward such that it can extend outward to a 90 degree angle and be parallel to the kitchen floor. The door (23) provides easy access to the oven chamber (24). The door also has a thick rectangular heat resistant glass window (22) which allows one to view the inner chamber of the oven so that one can glean a quick visual assessment of the item being cooked therein.

Situated below the oven is a pull-out metal drawer (2) which is used to store large cooking items such as baking sheets, trays, pizza stones, muffin pans, cutting boards, and such. The metal drawer (2) can be completely pulled so that it can be cleaned if necessary.

A plurality of burners (25) is located on a top surface of the stove. The front face (3) of the stove has a plurality of knobs, e.g., five circular knobs (11, 12, 13, 14, 15). Each knob has indicia (4, 5, 6, 7, 8) above it which provides a visual indicator as to which burner or function is controlled. As already discussed above, the central knob (13) controls oven functionality. A first knob (11) can control the front right burner. A second knob (12) can control the back right burner. A third knob (14) can control the front left burner. A fourth knob (15) can control the back left burner. While control knobs for four burners are shown, it is readily apparent that a top surface with five or six burners and a commensurate number of control knobs can be accommodated. Also, the burners can be either gas burners or electric burners. An advantage of gas burners is that they provide a better distribution of heat for cooking purposes.

The water dispenser (16) can include at least one faucet connected to body (1) and at least one water conduit (17) extending from a water source to the at least one faucet. The water dispenser (16) can be disposed at any suitable position of the body (1). In an embodiment, the at least one conduit (17) can include a first water conduit (19) and a second water conduit (20) extending along one or more sidewalls of the body (1). In an embodiment, conduits (19) and (20) are provided within or along an outer surface of the one or more sidewalls. In an embodiment, water is supplied to a filter (18) from a water source through the first water conduit (19) and filtered water exiting the filter (18) is supplied to the at least one faucet through the second water conduit (20). In an embodiment, the at least one faucet includes a first water dispensing faucet (9) and a second water dispensing faucet (10). The dual faucet arrangement (9, 10) can provide hot and one cold water. Although not shown, at least one of the faucets (9, 10) can include a protective cover to prevent unintended spillage. A protective cover is particularly useful for a hot water dispensing faucet. Although the dual faucets (9, 10) are shown extending from the front face (3) of the stove such that water is dispensed downwardly, the dual faucets (9, 10) can be provided at any other suitable position of the stove. The dual faucet arrangement can be adjacent to knob (15). The water filter (18) is configured for filtering out impurities or additives in the water provided by conduit (19).

It is to be understood that multi-functional stove is not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A multi-functional stove, comprising:
a rectangular body having an inner chamber, the rectangular body being defined by parallel and opposing first and second sidewalls, parallel and opposing third and fourth sidewalls, a top wall, and a bottom wall, the sidewalls extending between the top and bottom walls;
a door pivotally connected to one of the sidewalls of the rectangular body;
a plurality of burners connected to the top wall for providing cooking heat; and
at least one water dispenser connected to the rectangular body for dispensing water.

2. The multi-functional stove of claim 1, wherein the at least one water dispenser comprises at least one faucet for dispensing water and at least one conduit extending between the at least one faucet and a water source.

3. The multi-functional stove of claim 2, wherein the at least one faucet comprises a first faucet for dispensing cold water and a second faucet for dispensing hot water.

4. The multi-functional stove of claim 3, wherein the at least one faucet and the door are connected to a same sidewall.

5. The multi-functional stove of claim 1, further including a plurality of knobs on the body for controlling an amount of heat provided to the plurality of burners.

6. The multi-functional stove of claim 5, further including a plurality of visual indicia identifying a burner location corresponding to a respective knob.

7. The multi-functional stove of claim 1, wherein the inner chamber comprises at least one metal rack.

8. A multi-functional stove, comprising:
a rectangular body having an inner chamber, the rectangular body being defined by parallel and opposing first and second sidewalls, parallel and opposing third and fourth sidewalls, a top wall and a bottom wall, the sidewalls extending between the top and bottom walls;
a door pivotally connected to one of the sidewalls of the rectangular body;
a plurality of burners connected to the top wall for providing cooking heat; and
at least one water dispenser connected to the rectangular body for dispensing water, the at least one water dispenser comprising at least one faucet for dispensing water and at least one conduit extending between the at least one faucet and a water source.

9. The multi-functional stove of claim 8, wherein the at least one faucet comprises a first faucet for dispensing cold water and a second faucet for dispensing hot water.

10. The multi-functional stove of claim 8, wherein the at least one faucet and the door are connected to a same sidewall.

11. The multi-functional stove of claim 10, further including a plurality of knobs on the body for controlling an amount of heat provided to the plurality of burners.

12. The multi-functional stove of claim 11, further including a plurality of visual indicia identifying a burner location corresponding to a respective knob.

13. The multi-functional stove of claim 8, wherein the inner chamber comprises at least one metal rack.
